(19) United States
(12) Patent Application Publication
(10) Pub. No.: US 2026/0030549 A1
(43) Pub. Date: Jan. 29, 2026

(54) METHOD AND APPARATUS FOR INTELLIGENT LEARNING MANAGEMENT IN COMMUNICATION SYSTEM

(71) Applicant: ELECTRONICS AND TELECOMMUNICATIONS RESEARCH INSTITUTE, Daejeon (KR)

(72) Inventors: Ji Hyung KIM, Daejeon (KR); Cheulsoon KIM, Daejeon (KR); Sung-Hyun MOON, Daejeon (KR); Junghoon LEE, Daejeon (KR); Hoiyoon JUNG, Daejeon (KR)

(73) Assignee: ELECTRONICS AND TELECOMMUNICATIONS RESEARCH INSTITUTE, Daejeon (KR)

(21) Appl. No.: 19/276,815

(22) Filed: Jul. 22, 2025

(30) Foreign Application Priority Data
Jul. 24, 2024 (KR) 10-2024-0098024
Sep. 12, 2024 (KR) 10-2024-0125160
Jun. 27, 2025 (KR) 10-2025-0086034

(51) Int. Cl. G06N 20/00; H04L 41/16

(52) U.S. Cl. CPC G06N 20/00; H04L 41/16

(57) ABSTRACT

A method of a terminal may comprise: receiving a capability inquiry message from a base station; transmitting, to the base station, information on at least one support functionality supported by the terminal; receiving, from the base station, information on at least one candidate model related to the at least one support functionality; and transmitting information on an application functionality to be applied by the terminal to the base station based on the information on the at least one candidate model.

### CROSS-REFERENCE TO RELATED APPLICATIONS

This application claims priority to Korean Patent Applications No. 10-2024-0098024, filed on Jul. 24, 2024, No. 10-2024-0125160, filed on Sep. 12, 2024, and No. 10-2025-0086034, filed on Jun. 27, 2025, with the Korean Intellectual Property Office (KIPO), the entire contents of which are hereby incorporated by reference.

### BACKGROUND

### 1. Technical Field

The present disclosure relates to an intelligent learning management technique in a communication system, and more particularly, to an intelligent learning management technique in a communication system, which can enhance a quality of the communication system using artificial intelligent (AI)/machine learning (ML).

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

A communication system may be designed in consideration of various scenarios, service requirements, and potential system compatibility. In particular, in a 5G NR communication system, discussions on beam-based communication are actively underway in order to perform wideband communication in high-frequency bands. Accordingly, beam-based communication may be continually utilized. The communication system may improve performance using artificial intelligence (AI) and machine learning (ML). The communication system requires methods to identify AI/ML-based functionalities or models that are supported by a terminal. In addition, the communication system requires methods to identify AI/ML-based functionalities or models applicable to the terminal.

### SUMMARY

The present disclosure for resolving the above-described problems is directed to providing a method and an apparatus for intelligent learning management in a communication system, which can enhance a quality of the communication system using AI/ML.

An intelligent learning management method according to a first exemplary embodiment of the present disclosure, performed by a terminal, may comprise: receiving a capability inquiry message from a base station; transmitting, to the base station, information on at least one support functionality supported by the terminal; receiving, from the base station, information on at least one candidate model related to the at least one support functionality; and transmitting information on an application functionality to be applied by the terminal to the base station based on the information on the at least one candidate model.

The terminal may transmit the information on the at least one support functionality to the base station through one of user equipment (UE) capability information or UE assistance information.

The information on the at least one candidate model may include at least one of: identifier(s) of the at least one candidate model, initial values of the at least one candidate model, operational parameter values for training the at least one candidate model, model parameter values for model training of the at least one candidate model, a data set for the at least one candidate model, or a functionality of the at least one candidate model.

The information on the application functionality may include at least one corresponding model identifier for at least one corresponding model corresponding to the at least one candidate model, and the transmitting of the information on the application functionality may comprise: determining whether the terminal has the at least one corresponding model corresponding to the at least one candidate model; and in response to determining that the terminal has the at least one corresponding model, transmitting, to the base station, the information on the application functionality including the at least one corresponding model identifier for the at least one corresponding model.

The information on the application functionality may further include at least one of: whether the at least one corresponding model has been trained, a stabilization rate of the at least one corresponding model, or model parameter values for training the at least one corresponding model.

The method may further comprise: receiving, from the base station, information on a model to use based on the at least one corresponding model.

The method may further comprise: receiving, from the base station, a training request for the model to use; training the model to use according to the training request; and reporting, to the base station, a training result of the model to use.

The training result may further include at least one of a training status of the model to use or model parameter values for training.

An intelligent learning management method according to a second exemplary embodiment of the present disclosure, performed by a base station, may comprise: transmitting a capability inquiry message to a terminal; receiving, from the terminal, information on at least one support functionality supported by the terminal; transmitting, to the terminal, information on at least one candidate model related to the at least one support functionality; and receiving, from the terminal, information on an application functionality to be applied by the terminal based on the information on the at least one candidate model.

The information on the application functionality may further include at least one of: whether the at least one corresponding model has been trained, a stabilization rate of the at least one corresponding model, or model parameter values for training the at least one corresponding model.

The method may further comprise: determining a model to use based on the application functionality; and transmitting, to the terminal, information on the determined model to use.

The method may further comprise: transmitting, to the terminal, a training request for the model to use; and receiving, from the terminal, a training result of the model to use.

An intelligent learning management apparatus according to a third exemplary embodiment of the present disclosure, implemented as a terminal, may comprise: at least one processor, and the at least one processor may cause the terminal to perform: receiving a capability inquiry message from a base station; transmitting, to the base station, information on at least one support functionality supported by the terminal; receiving, from the base station, information on at least one candidate model related to the at least one support functionality; and transmitting information on an application functionality to be applied by the terminal to the base station based on the information on the at least one candidate model.

The information on the application functionality may include at least one corresponding model identifier for at least one corresponding model corresponding to the at least one candidate model, and in the transmitting of the information on the application functionality, the at least one processor may further cause the terminal to perform: determining whether the terminal has the at least one corresponding model corresponding to the at least one candidate model; and in response to determining that the terminal has the at least one corresponding model, transmitting, to the base station, the information on the application functionality including the at least one corresponding model identifier for the at least one corresponding model.

The information on the application functionality may further include at least one of: whether the at least one corresponding model has been trained, a stabilization rate of the at least one corresponding model, or model parameter values for training the at least one corresponding model.

The at least one processor may further cause the terminal to perform: receiving, from the base station, information on a model to use based on the at least one corresponding model.

The at least one processor may further cause the terminal to perform: receiving, from the base station, a training request for the model to use; training the model to use according to the training request; and reporting, to the base station, a training result of the model to use.

According to the present disclosure, a terminal can report to a base station functionalities that are supported by the terminal, and the base station can identify the functionalities that are supported by the terminal and inform the terminal of information required based on the identified functionalities. In addition, according to the present disclosure, the terminal can perform model training either in response to a request from the base station or autonomously, and can report a training result to the base station. Accordingly, the base station can identify the training result of the model that can be used by the terminal and can perform additional operations based on the trained model.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a block diagram illustrating a functional framework for radio access network (RAN) intelligence utilizing artificial intelligence (AI)/machine learning (ML).

FIG. 4 is a block diagram illustrating a framework of artificial intelligence/machine learning.

FIG. 5 is a sequence chart illustrating exemplary embodiments of a training method of an artificial intelligence/machine learning model.

FIG. 6 is a sequence chart illustrating exemplary embodiments of a training method of an artificial intelligence/machine learning model.

FIG. 7 is a block diagram of a test framework for testing a function based on artificial intelligence/machine learning.

FIG. 8 is a conceptual diagram illustrating exemplary embodiments of W, which is an AI/ML function of a terminal, G, which is an AI/ML function of a base station, and Z, which is an AI/ML function in which W and G are interlinked and operate as a single AI/ML function.

FIG. 9 is a sequence chart illustrating exemplary embodiments of an intelligent learning management method in a communication system.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

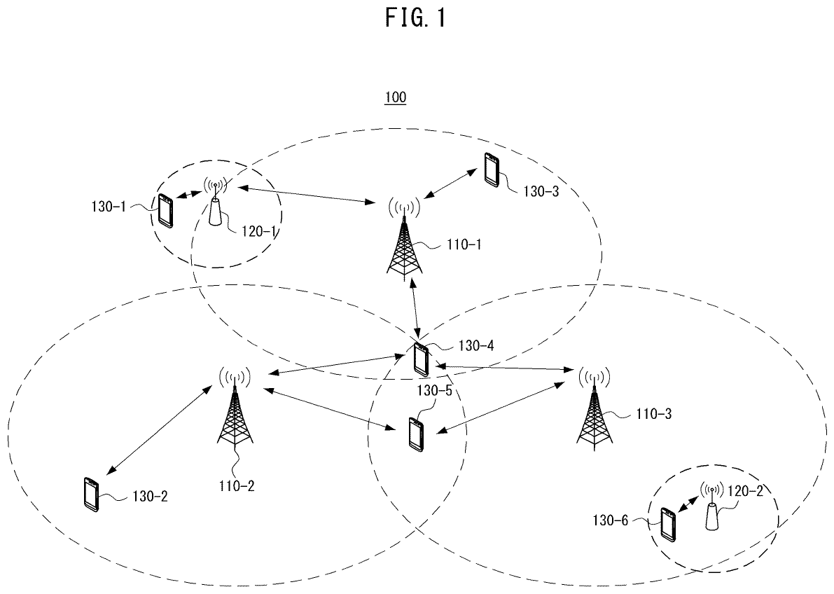

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, orthogonal frequency division multiple access (OFDMA) based communication protocol, single-carrier FDMA (SC-FDMA) based communication protocol, non-orthogonal multiple access (NOMA) based communication protocol, space division multiple access (SDMA) based communication protocol, or the like. Each of the plurality of communication nodes may have the following structure.

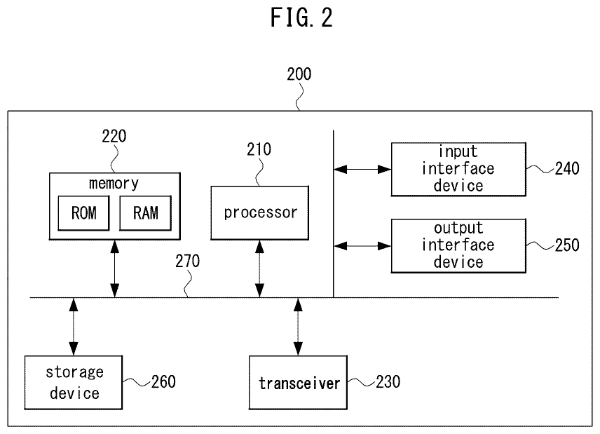

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), 5G Node B (gNB), base transceiver station (BTS), radio base station, radio transceiver, access point (AP), access node, road side unit (RSU), digital unit (DU), cloud digital unit (CDU), radio remote head (RRH), radio unit (RU), transmission point (TP), transmission and reception point (TRP), relay node, or the like. Each of the plurality of terminals 130-1, 130-2, 130-3, 130-4, 130-5, and 130-6 may be referred to as terminal, access terminal, mobile terminal, station, subscriber station, mobile station, portable subscriber station, node, device, or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), New Radio (NR), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (COMP) transmission, a carrier aggregation (CA) transmission, a transmission in unlicensed band, a device-to-device (D2D) communication (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

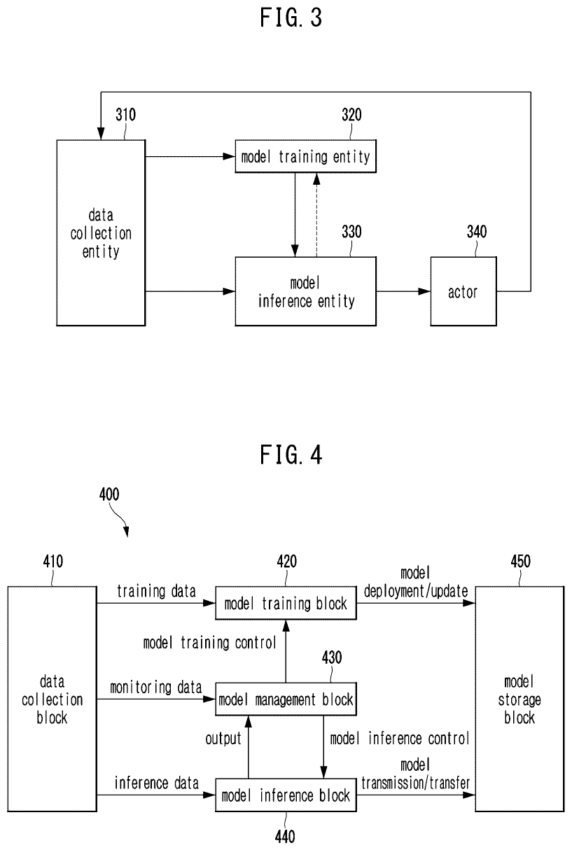

FIG. 3 is a block diagram illustrating a functional framework for radio access network (RAN) intelligence utilizing artificial intelligence (AI)/machine learning (ML).

Referring to FIG. 3, a communication system may be designed to apply RAN intelligence functions based on artificial intelligence (AI)/machine learning (ML) technologies. For example, specific AI/ML algorithms may be configured in various forms and may not be limited to a specific form. The present disclosure proposes a functional configuration of an AI/ML model, which is preconfigured based on AI/ML algorithms. In addition, the present disclosure proposes a beam management method performed based on inputs and outputs corresponding to the functional configuration of the preconfigured AI/ML model.

A data collection entity 310 may provide input data to a model training entity 320 and a model inference entity 330. For example, the input data may include at least one of measurement values by other network entities, feedback values by terminals, and feedback values for outputs of the AI/ML model, and may not be limited thereto.

The data collection entity may provide training data to the model training entity. The training data may be data provided for an AI/ML model training function. The data collection entity may provide inference data to the model inference entity. The inference data may be data provided for an inference function of the AI/ML model. The model training entity may perform training, validation, and testing of the AI/ML model. The model training entity may provide performance metrics for the AI/ML model through training, validation, and testing of the AI/ML model.

The model training entity may provide the AI/ML model to the model inference entity, and update the AI/ML model. The model inference entity may provide model performance feedback to the model training entity. In other words, the model training entity may perform training on the AI/ML model based on feedback from the model inference entity. The model training entity may again provide an updated AI/ML model to the model inference entity.

The model inference entity may receive the inference data from the data collection entity and may generate outputs through the received AI/ML model to provide the outputs to an actor 340. The actor may be an entity that performs actions based on the outputs. A result of the action performed by the actor may be fed back to the data collection entity and provided to the model training entity as training data.

In other words, the AI/ML model may be constructed through a training process based on the training data, and may perform functions based on the AI/ML model by receiving the inference data and outputting results. As a specific example, in a case of performing AI/ML-based beam management, the inference data may include candidate beam information, measurement information, movement path information, and other types of information.

The model inference entity may receive the inference data and may select a beam based on the received inference data. The model inference entity may provide information on the selected beam as output information to the actor. The actor may receive the information on the selected beam from the model inference entity to operate, and may provide a feedback on the operation result to the data collection entity. However, this is merely one example and may not be limited thereto. A specific method for performing beam management using AI/ML in FIG. 3 is described below.

Artificial intelligence, which is one of the core implementation technologies of a next-generation mobile communication system, is described. The next-generation mobile communication system may be, for example, a sixth generation (6G) system. The methods and technical features proposed in the present disclosure may not be limited to a 6G system. Artificial intelligence may be the most important and newly introduced technology in a 6G communication system. Artificial intelligence may not be involved in the 4G communication system. A 5G communication system may support artificial intelligence partially or in very limited situations. A 6G communication system may aim to support AI/ML-based automation of network functions. The development of machine learning may enable a more intelligent network for real-time communication in 6G. The introduction of AI into communication may simplify and enhance real-time data transmission. AI may determine optimal methods to perform complex target tasks by analyzing large volumes of data. In other words, AI may improve efficiency and reduce processing delay.

Time-consuming tasks such as handover, network selection, and resource scheduling may be performed instantly by using AI. AI may play an important role in machine-to-machine, machine-to-human, and human-to-machine communication. AI may be a core technology that enables fast and efficient communication in a brain-computer interface (BCI). A communication system based on AI may be supported by metamaterials, intelligent structures, intelligent networks, intelligent devices, intelligent cognitive radios, self-sustaining wireless networks, and machine learning.

Recently, attempts to integrate wireless communication systems with AI are emerging. These attempts may occur at the application layer, network layer, and the like. In particular, deep learning has been focused on the field of wireless resource management and allocation. These attempts may gradually evolve into the medium access control (MAC) layer and the physical layer. In particular, attempts to combine deep learning with wireless transmission at the physical layer are emerging.

AI-based physical layer transmission may mean applying signal processing and communication mechanisms based on AI drivers, instead of applying a traditional communication framework, in fundamental signal processing and communication mechanisms. For example, the signal processing and communication mechanisms based on AI drivers may include deep learning-based channel coding and decoding, deep learning-based signal estimation and detection, deep learning-based MIMO mechanisms, and AI-based resource scheduling and allocation.

Machine learning may be used for channel estimation and channel tracking. Machine learning may be used for power allocation and interference cancellation in the physical layer of the downlink (DL). Machine learning may be used for antenna selection, power control, and symbol detection in MIMO systems. The application of a deep neural network (DNN) for transmission in the physical layer may have the following issues.

Deep learning-based AI algorithms may require a large amount of training data to optimize training parameters. Deep learning-based AI algorithms may have limitations in acquiring training data in a specific channel environment. Due to this, deep learning-based AI algorithms may use a large amount of training data in an offline environment.

Static training based on training data in a specific channel environment may cause a contradiction between the dynamic characteristics and diversity of the wireless channel. Currently, most deep learning may models are designed for real-valued signals, whereas physical-layer communication often deals with complex-valued signals. In order to match the characteristics of wireless communication signals, further research may be needed on a neural network that detects signals in the complex domain. The present disclosure examines machine learning in more detail.

Machine learning may require a series of operations to train a machine to allow the machine to replace tasks that a person can perform. Alternatively, machine learning may require a series of operations to create a machine that can perform tasks that are difficult for a person to perform by training the machine. Data and a learning model may be necessary for machine learning. Learning methods in machine learning may be largely classified into three types, namely supervised learning, unsupervised learning, and reinforcement learning.

Neural network learning may be for minimizing errors in outputs. Neural network learning may repeatedly input training data into a neural network. Neural network learning may calculate an error between the output of the neural network and a target for the training data. Neural network learning may backpropagate the error in a direction from the output layer to the input layer of the neural network to update weights of the respective nodes in the neural network in a direction to reduce the error.

Supervised learning may use training data labeled with correct answers. Unsupervised learning may involve training data that is not labeled with correct answers. In other words, for example, in supervised learning related to data classification, the training data may be data in which each training datum has a labeled category. The labeled training data may be input into the neural network. The neural network may calculate an error by comparing the output (i.e. category) of the neural network with the label of the training data. The calculated error may be backpropagated in the neural network in a reverse direction (i.e. from the output layer to the input layer).

According to the backpropagation, connection weights of nodes in each layer of the neural network may be updated. An amount of change in the connection weight of each updated node may be determined according to a learning rate. A computation of the neural network for the input data and backpropagation of the error may constitute a learning cycle (e.g. epoch). The learning rate may be differently applied according to the number of repetitions of training cycles of the neural network. For example, a high learning rate may be used in an early stage of training the neural network to quickly secure a certain level of performance, thereby improving efficiency, and a low learning rate may be used in a later stage of training to improve accuracy.

Depending on characteristics of the data, a learning method may vary. For example, a communication system may aim to accurately predict data transmitted from a transmitting end at a receiving end. In such a case, the communication system may perform training using supervised learning, rather than unsupervised learning or reinforcement learning.

A learning model may correspond to a human brain. A most basic linear model may be considered as the learning model. However, a machine learning paradigm that uses a highly complex neural network structure such as an artificial neural network as the learning model may be referred to as deep learning.

A neural network core used as a learning method may include deep neural networks (DNNs), convolutional deep neural networks (CNNs), and recurrent neural networks (RNNs). The learning model may use deep neural networks, convolutional neural networks, and recurrent neural networks. Hereinafter, an AI/ML framework is described.

FIG. 4 is a block diagram illustrating a framework of artificial intelligence/machine learning.

Referring to FIG. 4, an AI/ML framework 400 may include a data collection block 410, a model training block 420, a model management block 430, a model inference block 440, and a model storage block 450. FIG. 4 illustrates merely one example of the AI/ML framework, and various entities/functions/blocks not illustrated in FIG. 4 may be added to the AI/ML framework, and at least some of the blocks illustrated in FIG. 4 may be omitted.

The data collection block 410 may collect data for various purposes such as model training, model inference, model monitoring, model selection, and model updating in life cycle management (LCM). The data collection block in FIG. 4 may conceptually represent data sources and entities that hold data for training, inference, and monitoring.

The data collection block in FIG. 4 may be conceptually illustrated as a single block. Data collection for training, inference, and monitoring may have various characteristics and requirements. Timescales (e.g. real-time or offline) of training and monitoring may require individual considerations.

With respect to training, training data may be initially generated in a network and terminals. Initial data may be collected by (or transmitted to) one or more data collection entities. Various subjects, such as a network-internal entity, external terminal/chipset/network vendor, network operator, and positioning service provider, may own the data collection entity

With respect to inference, inference data for a terminal (UE)-sided model and/or a UE part of a two-sided model may be directly transmitted or provided from a terminal. Inference data for a network-sided model and/or a network part of the two-sided model may be directly transmitted or provided from a network or may be transmitted from the terminal. With respect to monitoring, monitoring data for UE-side monitoring may be directly transmitted or provided from the terminal. Monitoring data for network-side monitoring may be directly transmitted or provided from the network or may be transmitted from the terminal.

Data collection for real-time operations such as real-time model monitoring, switching, and selection may cause considerable signaling overhead. On the other hand, infrequent data collection for reducing signaling overhead may cause latency for real-time model monitoring, switching, and selection.

The model training block 420 may perform both initial training and model updating. Generally, model training may be classified into model training performed together with model development and follow-up training for a developed model. The model training block 420 in FIG. 4 may be represented as a single block for simplicity.

Depending on a location of a dataset and/or a location of a model (or an untrained model), the training may be performed by a network-internal entity or an external entity such as terminal/chipset/network vendor, network operator, and positioning service provider. AI/ML model development may generally be a repeated process of data collection, model design, training, and performance verification. Careful implementation considerations for power consumption, hardware area, latency, and concurrency with other layer functions for AI/ML model development may be required.

The data collection block may collect large-scale field data. A supplier responsible for model development may use the collected large-scale field data. In general, model development may be performed as an offline engineering process by an engineering team, which accesses a large-scale dataset collected in the field. In other words, a decision on a model structure, device-specific optimization, and the number of models to be developed (e.g. generalizable models versus specific models) may vary depending on the large-scale field data.

When a supplier owning the data collection block is different from a supplier responsible for model development, the supplier responsible for model development may use the dataset. The use of the dataset by the supplier responsible for model development may be performed through explicit dataset sharing or provision of access to the collected dataset. The dataset sharing/access may be related to a two-sided model for which both a base station supplier and a terminal/chipset supplier participate in the model development and training process.

A model may be developed and trained. Thereafter, the model may be stored in a model repository or the model storage block 450, and may be delivered to a target device. The model may be compiled into an executable file for inference. Various methods may exist depending on a location where the model is trained, a format in which the model is stored/transferred, and a location where the model is hosted before transfer.

The model inference block may be a function that provides an AI/ML model inference output, such as a prediction or a decision. The model inference block may provide model performance feedback to the model training block. The model inference block may perform data preparation such as data preprocessing, cleaning, formatting, and transformation based on inference data received from the data collection block.

Model management may include functionality/model monitoring, selection, activation, deactivation, switching, fallback, and the like. Although FIG. 4 illustrates a single model management block, not all aspects of model management may be implemented at a single location. Some aspects of model monitoring, activation/deactivation, selection, switching, and fallback may be performed on the network side, and other aspects may be performed on the terminal side.

With respect to model selection, activation, deactivation, switching, and fallback for a UE-sided model and a two-sided model, the model management may consider a mechanism related to network-initiated decisions initiated by the network. The model management may consider a mechanism related to network-initiated decisions initiated by the terminal and requested to the network. The model management may consider a mechanism related to terminal-initiated decisions triggered based on an event configured by the network and reported to the network. The model management may be terminal-autonomous and may consider a mechanism related to terminal-initiated decisions reported to the network. The model management may be terminal-autonomous and may consider a mechanism related to terminal-initiated decisions not reported to the network.

The intelligence/advancement of node(s) and terminal(s) constituting a wireless communication network may be achieved through the technological development of artificial intelligence/machine learning. In particular, due to the intelligence of network/base station, various network/base station decision parameter values (e.g. transmission/reception power of each base station, transmission power of each terminal, precoder/beam of base station/terminal, time/frequency resource allocation for each terminal, duplex mode of each base station, etc.) may be quickly optimized, derived, and applied according to various environmental parameters (e.g. distribution/locations of base stations, distribution/positions/material of buildings/households, positions/movement directions/speeds of terminals, weather information, etc.). Many standardization organizations (e.g. 3GPP, Open Radio Access Network (O-RAN), etc.) may conduct discussions on various areas such as positioning, beam management, channel state information (CSI) compression and CSI prediction, and handover using AI/ML models.

Identification of an AI/ML model may be required in next-generation wireless communication systems for seamless utilization of AI/ML among multiple entities and/or devices. For example, a method in which a model is identified by a network and a terminal without over-the-air (OTA) signaling may be considered. A method in which a model is identified through OTA signaling based on initiation of an identification procedure by the network or the terminal may be considered. A method in which a model is identified through data collection-related configuration and/or instruction may be considered. A method in which a model is identified through transmission of a dataset may be considered. A method for identifying a model when the model is transferred from the network to the terminal may be considered.

Transfer of an AI/ML model may be considered in a next-generation wireless communication system for the utilization of AI/ML. Specifically, a model may be delivered to a terminal over-the-top (OTT) from an external device/server. A model may be transmitted to a terminal in a proprietary format. A model may be transferred to a terminal in an open format. A model may be transferred in an open format with a model structure known to the terminal. A model may be transferred in an open format with a model structure unknown to the terminal. A model storage location may be the wireless communication network or another location. A training location may be at least one of a terminal side, a network side, and a neutral site.

Hereinafter, a method of managing an AI/ML function proposed in the present disclosure is described. In the present disclosure, the AI/ML function may be replaced with AI/ML. Also, although the following methods are described based on a terminal and a base station, the following methods may also be extended and applied to a first device providing an AI/ML function and a second device controlling the first device and/or to devices providing the AI/ML function. Furthermore, the entities performing the operations of the following methods may be changed. For example, a procedure in which a terminal performs a first operation to a base station and the base station performs a second operation to the terminal may be interpreted as a procedure in which the base station performs the first operation to the terminal and the terminal performs the second operation to the base station.

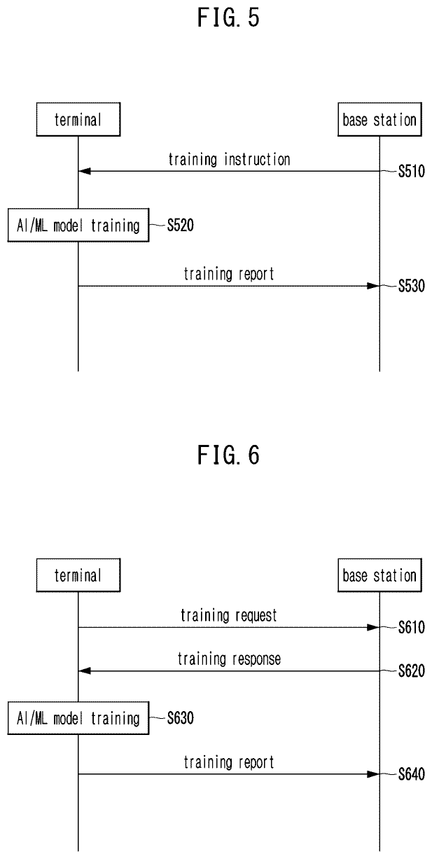

FIG. 5 is a sequence chart illustrating exemplary embodiments of a training method of an artificial intelligence/machine learning model.

Referring to FIG. 5, a base station may transmit a training instruction message to a terminal (S510). The terminal may receive the training instruction message from the base station. The terminal may perform training on an AI/ML model included in the terminal or an AI/ML model controlled by the terminal based on the received training instruction message (S520). The terminal may transmit a training report message including a training result to the base station (S530). The base station may receive the training report message including the training result from the terminal. The base station may identify the training result from the received training report message.

FIG. 6 is a sequence chart illustrating exemplary embodiments of a training method of an artificial intelligence/machine learning model.

Referring to FIG. 6, a terminal may transmit a training request message to a base station (S610). The base station may receive the training request message from the terminal. The base station may transmit a training response message including a training instruction to the terminal (S620). The terminal may receive the training response message including the training instruction from the base station. The terminal may perform training on an AI/ML model included in the terminal or an AI/ML model controlled by the terminal based on the training instruction (S630). The terminal may transmit a training report message including a training result to the base station (S640). The base station may receive the training report message including the training result from the terminal. The base station may obtain the training result from the training report message and identify the training result.

Various entities and/or communication devices such as terminals, base stations, and network servers may exchange information, messages, and instructions related to the AI/ML model to manage the AI/ML model in order to perform operations related to a framework for the AI/ML model, such as positioning, beam management, CSI compression, CSI prediction, AI/ML model identification, and AI/ML model transfer using the AI/ML model. Hereinafter, methods of managing an AI/ML model proposed in the present disclosure are described. The following methods may be applied to at least some of the steps in FIG. 5 and FIG. 6 described above. The present disclosure describes a method of managing parameters of the AI/ML model.

A base station and a terminal, or a base station, a relay, and a terminal may each have an AI/ML function and may operate the AI/ML function independently or in a collaborative manner.

The base station and the terminal may each have an AI/ML function and may operate the AI/ML function independently. The base station and the terminal may each have an AI/ML function and may operate the AI/ML function in a collaborative manner. The base station, the relay, and the terminal may each have an AI/ML function and may operate the AI/ML function independently. The base station, the relay, and the terminal may each have an AI/ML function and may operate the AI/ML function in a collaborative manner.

AI/ML management/operation may be performed according to a model, functionality, mode, subject, purpose, and the like. The model may represent an AI/ML model (e.g. AI/ML model for data collection, measurement, training, inference, etc.). Information on the model may include function values of the AI model, input/output values for training of the AI model, and/or input/output values for inference of the AI model.

The functionality may represent a purpose for which the AI/ML model is used (e.g. beam management, channel information estimation, position information estimation, handover, radio link failure, etc.). The mode may represent a scheme for data collection, measurement, training, and inference distinguished within the functionality. The subject may represent whether data collection, measurement, training, and/or inference is performed at the base station, the terminal, or both.

The purpose may represent an association among respective processes such as data collection, measurement, training, and/or inference. For example, information on a purpose may indicate that data collection and inference are associated. An AI/ML ID may be configured as a model ID, purpose ID, or another type of ID depending on the model, functionality, mode, subject, purpose, and the like. For example, the base station may deliver the AI/ML ID to the terminal through RRC signaling. The terminal may receive the AI/ML ID through the RRC signaling. The base station may deliver the AI/ML ID to the terminal through a MAC-CE or DCI. The terminal may receive information on the AI/ML ID from the base station through the MAC-CE or DCI.

AI/ML model parameter values may be composed of at least a portion or all of model initial values, operational parameter values for model training, and model parameter values for model training. The training may refer to learning of the model, and updating of the model may also be included in the training. The model initial values may represent initial values applied at the start of model training. The operational parameter values for model training may include the number (size) of model input/output values, type of model input/output values, learning rate, epoch, batch size, optimizer, dataset size, learning method, and the like.

The type of model input/output values may represent what values are used (e.g. reference signal received power (RSRP), signal-to-interference and noise ratio (SINR), etc.). The learning rate may be a control ratio for weight updates. The epoch may represent the number of times the dataset is repeatedly trained. The batch size may be a group of data samples used for a single weight update. The dataset size may represent the number of data samples in the entire dataset. The optimizer may be an optimization algorithm for weight updates, such as momentum, root mean square propagation (RMSProp), and adaptive moment estimation (ADAM). For example, in the case of using ADAM, the base station may transmit parameter values including beta values such as β=(0.9, 0.999) to the terminal. The terminal may receive the parameters including the beta values from the base station and may use the received beta values. Default values of the beta values may be predefined by the system or operations, administration, and maintenance (OAM) and may be used without separate transmission.

The number (size) of model input/output values and the type of model input/output values may be indicated in association with the AI/ML functionality. For example, the information may be included in an indication of a reference signal transmitted for measurement (e.g. synchronization signal block (SSB), channel state information reference signal (CSI-RS), positioning reference signal (PRS), or newly defined reference signal, etc.). The information may be implicitly decided/determined by the terminal. The number of model input/output values and the type of model input/output values may be configured to be included in the model initial values, the operational parameter values for model training, the model parameter values for model training, or the dataset.

A learning method of the AI/ML model may be classified into supervised learning, unsupervised learning, reinforcement learning, and the like. The learning method of the AI/ML model may include a function or algorithm required for training according to each learning method in the above-described information. For example, in the case of unsupervised learning, a performance metric may be included in the above-described information. In the case of reinforcement learning, a reward model, state, and reward may be included in the above-described information.

For example, in the case of unsupervised learning, in a scenario to maximize a sum-rate of the network, a channel of each transmission/reception pair may be used as an input of the AI model, and each transmission power may be predicted by the AI model. The AI model may calculate the sum-rate using the channel and the transmission power. The terminal may optimize the AI model in a direction to maximize the sum-rate. In the case of reinforcement learning, the base station may transmit a reward to the terminal based on a report from the terminal, which is related to the reward. The terminal may receive the reward from the base station.

For example, the model parameter values for model training may be values used for an initiating device (terminal, base station, relay, etc.) to configure the AI/ML model of a target device with which the coordinating device is associated. The dataset may include input and/or output data for training of the AI/ML model. The dataset may be composed of a training set, a validation set, and a test set. A final performance of the model may be evaluated with the test set. The validation set may be used to evaluate an expected final performance during the training process.

The initiating device or the target device may evaluate performance with the validation set at every predetermined interval of epochs while performing training with the training set and may confirm training performance and validation performance. The initiating device or the target device may compare the evaluated training performances and validation performances between adjacent epochs. The initiating device or the target device may determine convergence for the training performance and validation performance and terminate training if the training performance and validation performance no longer increase even as the epochs increase. Conversely, the initiating device or the target device may determine overfitting if a gap between the training performance and validation performance continues to widen, and may stop the training midway or request an additional training set. A criterion for overfitting may be indicated by the base station or may be autonomously determined by the terminal. The training stop or the request for additional training set may be reported or requested by the terminal to the base station in an event-driven manner.

Requirements and testing for AI/ML-based functionality may include various essential elements including inference, LCM procedures, data generation and collection, and generalization verification. Key requirements may include a performance monitoring procedure, a function/model management procedure, and corresponding latency and interruption requirements.

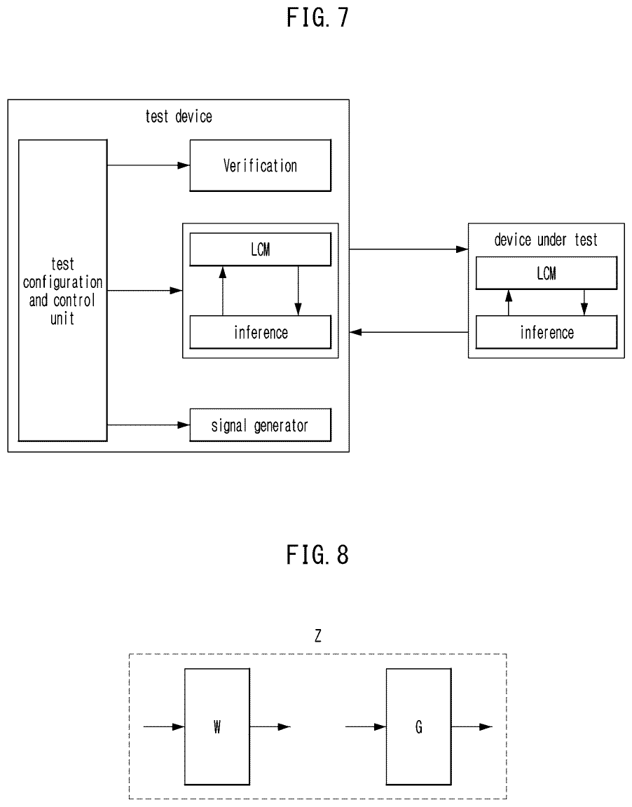

FIG. 7 is a block diagram of a test framework for testing a function based on artificial intelligence/machine learning.

Referring to FIG. 7, a test framework may be applicable to both a one-sided model (UE-sided model or network-sided model) and a two-sided model. In the case of a two-sided model, a test device may perform joint inference with an AI/ML model of a device under test (DUT) by integrating accompanying AI/ML models. The DUT may be a terminal or a base station.

The base station may configure a training set, a validation set and/or a test set of the dataset such that the terminal can distinguish them. Depending on the learning method, the dataset may be configured differently. For example, in the case of supervised learning, the dataset may include both inputs and outputs of the model. In the case of unsupervised learning, the dataset may include only inputs of the model. The dataset may explicitly indicate the configured scheme. The terminal may implicitly recognize the dataset configuration by recognizing the learning method. Conversely, the terminal may implicitly recognize the learning method by recognizing the dataset configuration.

The present disclosure may, for convenience, define model initial values, operational parameter values for model training, and model parameter values for model training. Each detailed component, such as initial model values, operational parameter values for model training, and model parameter values for model training, may be configured independently or grouped in any combination.

Hereinafter, training of AI/ML model is described.

The terminal may train an AI/ML model based on a dataset received from the base station. The terminal may perform training using only the terminal's own model (referred to as ‘W’ in the present disclosure). The terminal may perform training in association with a model of the base station (referred to as ‘G’ in the present disclosure).

The base station may instruct the terminal to perform training only with the terminal's own model through signaling. The terminal may receive, from the base station, the instruction to perform training only with the terminal's own model. Alternatively, the base station may instruct the terminal to perform training in association with a model of another device through signaling. The terminal may receive, from the base station, the instruction to perform training in association with a model of another device.

The base station may instruct the terminal to recognize/determine whether to perform training only with the terminal's own model or in association with a model of another device depending on whether model parameter values for model training are configured. The terminal may receive, from the base station, the instruction to recognize/determine whether to perform training only with the terminal's own model or in association with a model of another device depending on whether model parameter values for model training are configured.

For example, if model parameter values for model training are not configured, the terminal may determine to perform training only with the terminal's own model. In the case of training only with the terminal's own model, the input/output values of the dataset may be configured as the input/output values of W. In the case of training in association with G, the input/output values of the dataset may be configured as the input/output values of W, the input values of W and the output values of G, the input/output values of W and the output values of G, or the input/output values of Z (where Z refers to an AI/ML model in which W and G are interlinked and operate as a single AI/ML model in the present disclosure).

FIG. 8 is a conceptual diagram illustrating exemplary embodiments of W, which is an AI/ML function of a terminal, G, which is an AI/ML function of a base station, and Z, which is an AI/ML function in which W and G are interlinked and operate as a single AI/ML function.

Referring to FIG. 8, the terminal may configure initial values for W with model initial values indicated by the base station or with random values or previously configured values. Regarding what values to configure as the model initial values, the base station may configure the initial values. The base station may indicate the configured initial values to the terminal. The terminal may receive the initial values from the base station.

When the model initial values are not configured, the terminal may configure the model initial values as random values or values configured by the terminal itself. The base station may instruct the terminal to configure the model initial values as previously configured values or as currently configured values. The terminal may receive, from the base station, the instruction to configure the model initial values as the previously configured values or the currently configured values.

When the terminal and the base station perform training in association, the base station may transmit, to the terminal, model parameter values for model training for G in order to configure G at the terminal or may transmit, to the terminal, model parameter values for model training for Z. When the terminal and the base station perform training in association, the terminal may receive, from the base station, the model parameter values for model training for G in order to configure G at the terminal or the model parameter values for model training for Z.

When the terminal receives the model parameter values for model training for G, the terminal may virtually configure G received from the base station. When Z is configured based on the configuration of W and G, the terminal may train Z using the received dataset. When the terminal receives the model parameter values for model training for Z, the terminal may configure Z and train Z using the received dataset. The terminal may train Z by applying operational parameter values for model training received during the training.

When the terminal performs additional training for G, the base station may instruct the terminal to report model parameter values for model training that constitute W completed after training based on the dataset. The terminal may receive, from the base station, the instruction to report model parameter values for model training that constitute W completed after training based on the dataset. When the terminal additionally trains G, the terminal may report, to the base station, model parameter values for model training that constitute W completed after training based on the dataset. The base station may receive, from the terminal, the model parameter values for model training that constitute W completed after training based on the dataset.

Similarly to the training procedure of the terminal, the base station may virtually configure W based on the reported model parameter values for model training of W, and may configure Z together with G to perform training. The above-described procedure may be continuously performed based on a determination of the base station or values reported by the terminal. The above-described procedure may be terminated based on a determination of the base station or values reported by the terminal. When the procedure is continued, the procedure may proceed based on the updated W and G. When the base station does not instruct additional training to the terminal or instructs reporting according to inference, the terminal may perform reporting and inference based on model parameter values configured through training up to that point. Hereinafter, a stabilization rate is described.

The terminal may report to the base station a stabilization rate of W after training W based on the dataset. The stabilization rate may indicate a convergence rate or convergence status of the parameters constituting the model according to the training, or a correctness rate for the validation set and/or test set, or a success probability or success status for the validation set and/or test set. The stabilization rate of W may be identical to a performance metric for performance monitoring for inference.

The terminal may report, to the base station, a stabilization rate of Z, in which W is interlinked with G, together with or instead of W. The base station may indicate to the terminal the module for which the stabilization rate is to be reported. The terminal may receive, from the base station, the instruction on the module for which the stabilization rate is to be reported. The terminal may report the stabilization rate to the base station for the module specified in the received instruction.

Signaling for the stabilization rate may be configured through quantization. Quantization levels may be set, and the signaling may be configured based on the quantization levels. When the base station configures the stabilization rate according to the quantization levels, the base station may transmit information on a reference value or range of each corresponding quantization level to the terminal. The terminal may receive, from the base station, the information on the reference value or range of each corresponding quantization level.

Regarding whether reporting is to be performed, the base station may indicate to the terminal whether to report. The terminal may receive the reporting instruction from the base station and perform reporting based on the received reporting instruction. The base station may request the terminal to report based on an event. The terminal may receive a request from the base station to report based on an event and may report to the base station based on the event. The base station may transmit some or all of operational parameter values for model training based on the reported values. The base station may modify the dataset based on the reported values and transmit the modified dataset to the terminal. The terminal may receive some or all of the operational parameter values for model training from the base station based on the reported values. The terminal may receive the modified dataset from the base station.

The operational parameter values for model training may be changed based on the stabilization rate reported by the terminal or based on a request from the terminal. The operational parameter values for model training may be changed based on a determination of the base station. For example, the base station may directly configure signaling for some or all of the operational parameter values and indicate the configured parameter values to the terminal. The base station may configure some or all of the operational parameter values as a table and indicate an index within the configured table. The terminal may receive some or all of the operational parameter values through direct signaling from the base station. The terminal may receive the index within the corresponding table configured for some or all of the operational parameter values from the base station. For example, changes in parameter values, such as the epoch, may be configured through the table.

Hereinafter, a process ID is described.

By setting a process ID for independent or joint training for W and G, the terminal and the base station may recognize mapping with previous W and G and perform continuous training (or updating). The base station may set a process ID and indicate the process ID to the terminal. The terminal may receive the process ID from the base station. A maximum value of the process ID may be set. The maximum value may be configured through system information or RRC signaling.

The process ID may be set for W, G, and/or Z. When there is no specific indication for the same process ID, the terminal may use the same dataset and the same operational parameter values for model training and may configure the model initial values as currently configured values. In the case of joint training, the base station may transmit new model parameter values for model training of G together with the process ID to the terminal. In the case of joint training, the terminal may receive new model parameter values for model training of G together with the process ID from the base station.

The terminal may report new model parameter values for model training of W to the base station. The base station may receive the new model parameter values for model training of W from the terminal. The terminal may newly or continuously train W depending on a functionality. The terminal may configure a different W depending on the functionality. When the same functionality (e.g. beam management, channel information estimation, position information estimation, etc.) is used, the terminal may newly or continuously train W. When a different functionality is used, the terminal may configure a different W.

The base station may indicate a functionality to the terminal. The terminal may receive the indication on the functionality from the base station and may recognize its own functionality as the functionality received from the base station. If no new functionality indication is received from the base station, the terminal may recognize that training is continuously performed for the existing functionality. For the functionality, the terminal may replace the process ID with a functionality ID, or map or link the process ID with a functionality ID, or configure a functionality ID.

Hereinafter, data collection for AI/ML is described.

The data to be collected may be determined according to inference performance monitoring for data collection. The base station may instruct the terminal to report data measured and/or inferred by the terminal. The terminal may receive, from the base station, the instruction to report data measured and/or inferred by the terminal.

With respect to data collection, the terminal may independently collect data. With respect to data collection, when the terminal performs performance monitoring, the terminal may calculate a performance metric for performance monitoring based on performance inferred through measurement. If the calculated performance metric is equal to or greater than a reference value, the terminal may collect the corresponding data. If a quality of measurement values is equal to or greater than a reference value, the terminal may collect the corresponding data.

The base station may instruct the terminal to collect data. The terminal may receive the data collection instruction from the base station and may collect data according to the received data collection instruction. The base station may instruct the terminal to perform an AI functionality independently. The terminal may receive, from the base station, the instruction to perform an AI functionality independently. The terminal may perform the AI functionality independently according to the instruction to perform the AI functionality independently. The terminal may collect data when the AI functionality is performed independently according to the instruction from the base station.

The corresponding data may include measurement values and result values and/or inference values obtained through measurement. The result values and/or inference values obtained through measurement may be output values of W, G, or Z. The measurement values and the result values and/or inference values obtained through measurement may be paired. The pairing may be configured in the same manner as the signaling configuration method of the dataset. For example, the result values obtained through measurement may be K beams with the largest RSRP or the corresponding RSRP(s) for beam management.

The measurement values may be used as input values of W, and the result values and/or inference values obtained through measurement may be used as output values of W. The reference value for the quality of measurement values for data collection may include an RSRP, S(I)NR, or hypothetical BLER of the measurement values. The base station may indicate the reference value to the terminal. The terminal may receive the reference value from the base station. The base station may instruct the terminal to report the collected data. The terminal may receive, from the base station, the instruction to report the collected data. The terminal may report the collected data to the base station according to the instruction received from the base station. The base station may receive the report from the terminal. When collecting data, the terminal may report a buffer size to the base station according to an instruction of the base station or a request of the terminal. The base station may receive the report on the buffer size from the terminal.

The terminal may store the dataset reported to the base station. Regarding whether to store, when the AI functionality of the terminal is operating, the terminal may implicitly store the reported dataset. The base station may instruct the terminal to store the reported dataset. The terminal may receive, from the base station, the instruction to store the dataset. The terminal may store the dataset according to the instruction to store the dataset, which is received from the base station.

When the base station indicates a dataset to utilize the data set, the base station may indicate an ID of a reference signal (e.g. SSB, CSI-RS, PRS, etc.) transmitted for measurement. The terminal may receive the reference signal ID from the base station. The terminal may utilize measurement values of the corresponding reference signal stored by the terminal, result values obtained through the measurement, and/or inference values as the dataset. Alternatively, as described above, the base station may directly transmit the dataset.

The base station may instruct the terminal to exclude a portion of the dataset used by the terminal. The terminal may receive the instruction from the base station to exclude a portion of the dataset used by the terminal. The base station may instruct the terminal to exclude specific data or a portion of the dataset used by the terminal. The terminal may receive the instruction from the base station to exclude specific data or a portion of the dataset used by the terminal.

For example, in relation to the instruction, the base station may indicate the portion to be excluded to the terminal using a reference signal ID or index(es) in the dataset. The base station may transmit a signal indicating the portion to be excluded to the terminal using the reference signal ID or index(es) in the dataset through a MAC-CE, DCI, or RRC signaling. The terminal may receive the signal from the base station indicating the portion to be excluded using the reference signal ID or index(es) in the dataset. The terminal may receive the signal indicating the portion to be excluded through the MAC-CE, DCI, or RRC signaling using the reference signal ID or index(es) in the dataset.

The base station may add new data to the dataset used by the terminal. To this end, the base station may transmit an instruction to the terminal to add new data to the dataset used by the terminal. For example, the base station may transmit a signal indicating the data to be added to the terminal using a reference signal ID. The terminal may receive the signal from the base station indicating the data to be added using the reference signal ID. The terminal may add the data corresponding to the received reference signal ID to the dataset. The base station may directly transmit new data to be added to the terminal. The terminal may receive new data to be added from the base station. The terminal may add the received new data to the dataset. The base station may transmit the instruction or the data to the terminal through a MAC-CE, DCI, or RRC signaling. The terminal may receive the instruction or the data through the MAC-CE, DCI, or RRC signaling.

When performance monitoring is performed at the base station rather than the terminal, the terminal may report all measurement values and result values and/or inference values obtained through the measurement to the base station. The base station may receive all measurement values, and result values and/or inference values obtained through the measurement from the terminal.

When a reference value for performance monitoring of data collection by the terminal is not configured, the terminal may report all measurement values and result values and/or inference values obtained through the measurement to the base station. The reference value for performance monitoring may be a quality reference value for the measurement values or a performance monitoring reference value for the inference. The measurement values and the result values and/or inference values obtained through the measurement may be configured as being paired. The base station may receive all measurement values and the result values and/or inference values obtained through the measurement from the terminal.

Hereinafter, signaling for candidate models is described.

For example, a server or the base station may configure a model of the base station and a supported model of the terminal, respectively or together, and transmit information on the model of the base station or the supported model of the terminal to the terminal. The terminal may receive the information on the model of the base station or the supported model of the terminal from the server or the base station. The base station may define candidate models (candidate models for G) that can be used. For example, the base station may define models defined in specifications, such as DNN, convolutional neural network (CNN), and long short-term memory (LSTM), as candidate models that can be used by the base station. The base station may define widely known models as candidate models that can be used by the base station. The base station may transmit information on the candidate models that can be used by the base station to the terminal. The terminal may receive information on the candidate models that can be used by the base station from the base station.

The base station may define candidate models of W that can be used by the terminal and supported by the base station. For example, the base station may define models defined in specifications, such as DNN, CNN, and LSTM, as candidate models that can be used by the terminal. The base station may define widely known models as candidate models that can be used by the terminal. The base station may transmit information on the candidate models that can be used by the terminal to the terminal. The terminal may receive information on the candidate models that can be used by the terminal from the base station. The candidate models that can be used by the terminal may indicate models for which the base station can support AI functionality of the terminal.

The base station may define candidate models of Z that can be used by the base station and the terminal in association. For example, the base station may define models defined in specifications, such as DNN, CNN, and LSTM, as candidate models that can be jointly used by the base station and the terminal. The base station may define widely known models as candidate models that can be jointly used by the base station and the terminal. The base station may transmit information on the candidate models that can be jointly used by the base station and the terminal to the terminal. The terminal may receive information on the candidate models that can be jointly used by the base station and the terminal from the base station.

The candidate models (i.e. candidate models of Z) may be indicated or represented separately for W and G that constitute Z. Each of the candidate models (i.e. candidate models of Z) may be indicated or represented as a single model as a whole. For example, candidate models defined in specifications may be configured in the form of a table or an array. The base station may transmit index(es) of the candidate models configured in a table or an array to the terminal. When transmitting the index(es) to the terminal, the base station may transmit the index(es) along with information indicating the above-described training method for each of the candidate models to the terminal. The base station may also independently configure the candidate models and the above-described training method when transmitting the index(es) to the terminal. The terminal may receive the index(es) of the candidate models configured in a table or an array from the base station. The terminal may receive the candidate models and the information indicating above-described training method together when receiving the index(es) from the base station. The terminal may also receive the candidate models and the information indicating the above-described training method independently when receiving the index(es) from the base station.

The terminal may receive the instruction or information on the candidate models that can be used by the terminal or the candidate models that can be jointly used by the base station and the terminal from the base station. When the terminal has a corresponding model functionality, the terminal may wait for or recognize a procedure for AI operations with the base station. The terminal may report the corresponding model with the functionality to the base station. The base station may receive the report on the corresponding model with the functionality from the terminal.

A terminal having AI functionality may not receive information on the candidate models from the base station. The base station may transmit a UE capability inquiry message to the terminal. The terminal may receive the UE capability inquiry message from the base station. The terminal may report its AI functionality or information on the corresponding model to the base station through UE capability information or UE assistance information (UAI). The base station may receive AI functionality or information on the corresponding model from the terminal through the UE capability information or UAI.

A terminal that possesses a model included in the candidate models of W constituting the candidate models of Z may recognize that AI operations are performed in cooperation with the base station. The above-described reporting method for the candidate models may also be applied to the reporting method for the training method.

When AI operations need to be performed in the terminal, the terminal may recognize the information through the instruction from the base station. Regarding the AI operations of the terminal, the base station may separately indicate whether the AI operations are to be performed independently at the terminal or in cooperation with the base station. The terminal may not receive model parameter values for model training of G. In this case, the terminal may recognize that AI operations are performed independently at the terminal.

When the terminal receives model parameter values for model training of G, the terminal may recognize that the training is performed in cooperation with the base station and follow a cooperative training procedure. When the terminal recognizes that the AI operations are performed independently without cooperation with the base station, the terminal may follow an independent operation procedure.

For example, the terminal may independently operate AI/ML functionality. In such a case, the base station may not need to recognize the model of the terminal. The base station may transmit parameters associated with input/output of a candidate model to the terminal along with an indication regarding the candidate model. The terminal may receive the parameters associated with input/output of the candidate model from the base station along with the indication regarding the candidate model. The base station may transmit only the parameters associated with input/output of the candidate model to the terminal. The terminal may receive the parameters associated with input/output of the candidate model from the base station. The parameters associated with input/output of the candidate model may correspond to all or a part of the above-described operational parameter values for model training.

Hereinafter, signaling related to AI/ML is described.

The above-described candidate model (e.g. candidate model identifier) and parameters associated with the model (e.g. model initialization values, operational parameter values for model training, model parameter values for model training, dataset, functionality, mode, subject, purpose, model to use, etc.) may be configured individually. The above-described candidate model and parameters associated with the model (e.g. model initialization values, operational parameter values for model training, model parameter values for model training, dataset, functionality, mode, subject, purpose, model to use, etc.) may be configured together.

When the candidate model and parameters associated with the corresponding candidate model are configured individually, the base station may transmit information on the candidate model to the terminal through a specific system information block (SIB). The base station may configure the SIB to be received only by terminals having AI functionality. The base station may configure the SIB to be received by all terminals. The parameters associated with the corresponding candidate model may be configured individually. The parameters associated with the corresponding candidate model may be configured together with the candidate model.

The candidate model (e.g. candidate model identifier), the model initialization values of the corresponding candidate model, the operational parameter values for model training, the model parameter values for model training, the dataset, the functionality, the mode, the subject, the purpose, etc., may be configured in a single table. The candidate model, the model initialization value of the corresponding model, the operational parameter values for model training, the model parameter values for model training, the dataset, the functionality, the mode, the subject, the purpose, etc. may be partially configured together and partially configured independently. The candidate model, the model initialization value of the corresponding model, the operational parameter values for model training, the model parameter values for model training, the dataset for model training, the functionality of the model, the mode, the subject, and the purpose may all be configured independently.

For example, the candidate model, the subject, the purpose, and the model initialization values may be configured together. The operational parameter values for model training, the model parameter values for model training, the mode, and the dataset may be configured together. When configured partially or individually, such configurations may include associated IDs. For example, the base station may instruct the terminal to use a dataset ID 2 and a functionality ID 3 for a model ID 1.

The base station may indicate the above-described information/instruction to the terminal through RRC signaling or LTE Positioning Protocol (LPP) signaling. The base station may indicate the above-described information/instruction to the terminal through a MAC-CE or DCI. The base station may indicate, as a model ID, a model to be used among the candidate models during operation. The base station may preconfigure all or a part of the candidate model, the model initialization value of the corresponding model, the operational parameter values for model training, the model parameter values for model training, the dataset, the functionality, the mode, the subject, the purpose, etc., in a cell-specific manner. Subsequently, the base station may update all or a part of the candidate model, the model initialization value of the corresponding model, the operational parameter values for model training, the model parameter values for model training, the dataset, the functionality, the mode, the subject, the purpose, etc. in a cell-specific, group-specific, or UE-specific manner.

When configured in a group-specific manner, the configuration may be applied to terminals using the same model. When configured in a group-specific manner, the configuration may be applied to terminals using the same functionality, mode, subject, and purpose. As described above, the base station may transmit information on candidate models that can be used by the terminal to the terminal. The base station may transmit information on candidate models that can be jointly used by the base station and the terminal. The terminal may receive information on candidate models that can be used by the terminal from the base station. The terminal may receive information on candidate models that can be jointly used by the base station and the terminal from the base station.

When the terminal has a model corresponding to the candidate model, the terminal may report the presence of the model to the base station through UE capability information or UAI. When reporting, the terminal may report an ID of the corresponding model to the base station. The base station may receive the UE capability information or the UAI indicating the presence of the model from the terminal. The base station may receive the model ID from the terminal.

When the terminal does not have the corresponding model, the terminal may not report. When the terminal does not have the corresponding model, the terminal may report the absence of the model. When the terminal does not have the corresponding model but has another model, the terminal may report the another model.

When reporting the absence of the model, the terminal may report to the base station using a signaling configured with a specific index. The base station may receive the report indicating that the model is absent from the terminal. The base station may receive a report on another model from the terminal. The base station may recognize the another model based on the model information received from the terminal.

The base station may indicate an actual model to be used during AI operations to the terminal. The base station may indicate the model to be used to the terminal through a model ID of the corresponding model. The base station may transmit the indication on the model to be used in response to the report on the model received from the terminal. The terminal may receive the indication from the base station regarding the actual model to be used during AI operations. The terminal may receive the model ID of the model to be used from the base station. The terminal may receive the indication on the model to be used in response to the report on the model transmitted by the terminal.

In a first step, the base station may indicate transmission of the base station's candidate models to the terminal. In a second step, the terminal may report the corresponding model of the terminal to the base station. In a third step, the base station may indicate a model to be used to the terminal. Alternatively, in a first step, the terminal may report the corresponding model to the base station. In a second step, the base station may indicate the model to be used to the base station.

The procedure may be applied to four-step/two-step procedures such as initial access, handover, and (re) synchronization. The procedure may also be separately performed for four-step/two-step procedures such as initial access, handover, and (re) synchronization. For example, in the four-step procedure of initial access, the terminal may report the corresponding model to the base station through Msg3. The base station may indicate the model to be used to the terminal through Msg4. In the two-step procedure of initial access, the terminal may report the corresponding model to the base station through MsgA. The base station may indicate the model to be used to the terminal through MsgB.

When reporting the corresponding model, the terminal may also report a training status and/or model parameter values for model training to the base station. The report on the training status may include information on whether training has been performed and/or the above-described stabilization rate. The base station may instruct the terminal to report the training status and/or the model parameter values for model training. The terminal may report the training status and/or the model parameter values for model training to the base station according to the instruction from the base station. The terminal may report the training status and/or the model parameter values for model training to the base station per functionality. The terminal may report the training status and/or the model parameter values for model training to the base station during an initial access or handover procedure.

The above-described instruction/information for the candidate model and the report from the terminal may be performed for functionality(ies) instead of candidate model(s). In other words, the terminal may have the corresponding functionality. The base station may transmit a UE capability inquiry message to the terminal. The terminal may receive the UE capability inquiry message from the base station. The terminal may support the corresponding functionality. The terminal may report the presence of the corresponding functionality to the base station through UE capability information or UE Assistance Information (UAI). When the functionality is not present, the terminal may not report, may report the absence of the function, or may report another functionality that the terminal possesses. Also, the configuration/procedure for the above-described instruction/information on the candidate model(s) and the terminal's report may be applied when all or a part of the candidate model, functionality, mode, subject, and purpose are configured together.

Meanwhile, the above-described instruction/information on the candidate model(s) may be replaced with parameters associated with input/output of the candidate model in the case where the terminal independently operates AI/ML functionality. When AI operations are performed, an indication regarding the model used during the AI operations may be transmitted. The instruction regarding the model used may also be transmitted when model switching is performed or when the model is turned on/off. The indication regarding the model to be used in the case of AI operations, model switching, or model on/off may be transmitted through a control channel.

Hereinafter, pre-training of AI/ML is described. Although the following description is based on the terminal, the following content may also be applied to devices other than the terminal, such as a base station or server including an AI/ML functionality.

For example, the terminal may perform self-training or pre-training for AI/ML. The base station may instruct the terminal to perform self-training or pre-training. The terminal may receive the instruction on self-training or pre-training from the base station. The terminal may perform self-training or pre-training according to the instruction from the base station. Depending on a category of the terminal, the terminal may perform self-training or pre-training even without the instruction from the base station. The terminal may perform training based on a dataset owned by the terminal. The terminal may perform training based on a dataset collected according to the above-described data collection.

The terminal may report a training status for the self-training or pre-training to the base station. The training status may include whether training has been performed and/or the above-described stabilization rate. The base station may instruct the terminal to report the training status and/or the model parameter values for model training. The terminal may report the training status and/or the model parameter values for model training to the base station according to an instruction from the base station. The base station may receive the training status and/or the model parameter values for model training through UE capability information or UE assistance information (UAI). The terminal may report the training status and/or the model parameter values for model training to the base station together with the report on the model in the above-described procedure of indicating the model to be used.

As described above, the terminal and the base station may perform training in cooperation. The base station may recognize, from the report of the terminal's training status, that training for AI/ML has not been performed at the terminal. In such a case, the base station may proceed with a training procedure for W after the pre-training. The base station may recognize, from the report of the terminal's training status, that pre-training for AI/ML has been performed at the terminal. In such a case, the base station may not receive the report of the model parameter values for model training for W. The base station may instruct the terminal to report the model parameter values. The terminal may receive the instruction from the base station regarding the report of the model parameter values.

When the training status and the model parameter values have already been reported from the terminal, the base station may virtually construct W and perform training for Z. For training, the base station may request information on a dataset used in the pre-training from the terminal. The terminal may receive the request for information on the dataset used in the pre-training from the base station. The terminal may report information on the dataset to the base station in response to the request. The base station may receive the information on the dataset from the terminal.

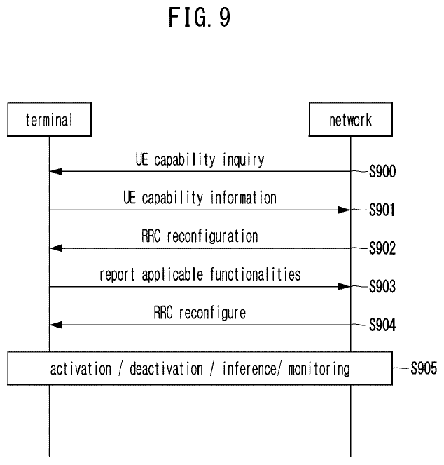

FIG. 9 is a sequence chart illustrating exemplary embodiments of an intelligent learning management method in a communication system.

Referring to FIG. 9, the network (e.g. base station) may transmit a UE capability inquiry message to the terminal to initiate a procedure in which the terminal reports an AI/ML support function (S900) (hereinafter referred to as a first step). The terminal may receive the UE capability inquiry message from the network. The terminal may transmit a UE capability information message to the network (S901) (hereinafter referred to as a second step). The network may receive the UE capability information from the terminal. The UE capability information message may include information on functionalities supported by the terminal.

The network may transmit an RRC reconfiguration message to the terminal (S902) (hereinafter referred to as a third step). The terminal may receive the RRC reconfiguration message from the network. The RRC reconfiguration message may include a content indicating that the terminal is allowed to report UE assistance information through OtherConfig. The network may configure one or more CSI report configurations for inference configuration at the terminal. The network may configure one or more parameter sets related to inference at the terminal. The parameter sets may not be configured as CSI report configurations. The parameter sets may include information related to Set A, information related to Set B, and information related to reporting content. The parameter sets may include time information for measurement and time information for prediction.

The associated IDs may be configured based on an operation scheme assumed within the CSI framework. The CSI report configuration for terminal-sided model inference may not be immediately activated upon completion of the third step. The associated IDs may be configured as part of the inference-related parameter set or independently of the inference-related parameter set.

The RRC reconfiguration message may include additional conditions on the network side. The RRC reconfiguration message may include configuration information of functionalities supported by the network. The terminal may transmit an applicability report message including information on applicable functionalities to the base station (S903) (hereinafter referred to as a fourth step). The corresponding report may include information on the associated IDs. The terminal may report to the network the applicability of at least one among one or more CSI reporting configurations or one or more inference-related parameter sets through the applicability report message. When one or more CSI reporting configurations are configured in the third step, aperiodic and semi-persistent CSI reporting related thereto may be activated or triggered by the network after the applicability is reported. Periodic CSI reporting related thereto may be deemed to be activated only when the applicability of the corresponding CSI reporting configuration is reported in an RRC reconfiguration complete message.

The base station may receive the applicability report message from the terminal and may identify the functionalities applicable to the terminal. The terminal may transmit the applicability report message to the network when the applicable functionalities are configured or changed through UE capability information. The terminal may transmit the applicability report message to the network when the terminal is requested to report applicable functionalities in response to the additional conditions on the network side in the third step.

Between the third step and the fourth step, the terminal may distinguish applicable functionalities based on i) additional conditions on the network side, ii) additional conditions internally recognized at the terminal, and iii) model availability within the terminal. The network may transmit an RRC reconfiguration message to the terminal (S904) (hereinafter referred to as a fifth step). The network may configure a configuration for CSI report for inference to the terminal through the RRC reconfiguration message. The associated IDs may be configured based on an operation scheme assumed within the CSI framework. The fifth step may be optional and may be omitted when the CSI report configuration has already been configured in the third step. For beam management, a plurality of inference-related CSI reportings for the terminal-sided model may be configured, activated, or triggered. Aperiodic and semi-persistent CSI reporting related thereto may be activated or triggered by the network after the applicability is reported. Periodic CSI reporting related thereto may be deemed to be activated only when the applicability of the corresponding CSI report configuration is reported in an RRC reconfiguration complete message.

The terminal may receive the RRC reconfiguration message from the network. The network may not provide inference configuration based on supported functionalities to the terminal in the third step. In such a case, the terminal may report the applicable functionalities to the network. Subsequently, the network may configure the inference configuration to the terminal through the RRC reconfiguration message. The network may provide inference configuration to the terminal in the third step. In such a case, whether to provide updated configuration may be determined according to an implementation. The network and the terminal may perform activation, deactivation, inference, and monitoring of the AI/ML model (S905).

The various methods and exemplary embodiments proposed in the present disclosure may be applied to at least a portion of the configurations or procedures described based on the drawings of the present disclosure, including FIG. 5 and FIG. 6. For example, specific information/indicator/identifier proposed in the present disclosure may be applied to at least a portion of the procedures described in the present disclosure, such as a message transmission procedure, such that the specific information/indicator/identifier may be included in the message.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving a capability inquiry message from a base station;
transmitting, to the base station, information on at least one support functionality supported by the terminal;
receiving, from the base station, information on at least one candidate model related to the at least one support functionality; and
transmitting information on an application functionality to be applied by the terminal to the base station based on the information on the at least one candidate model.

2. The method according to claim 1, wherein the terminal transmits the information on the at least one support functionality to the base station through one of user equipment (UE) capability information or UE assistance information.

3. The method according to claim 1, wherein the information on the at least one candidate model includes at least one of: identifier(s) of the at least one candidate model, initial values of the at least one candidate model, operational parameter values for training the at least one candidate model, model parameter values for model training of the at least one candidate model, a data set for the at least one candidate model, or a functionality of the at least one candidate model.

4. The method according to claim 1, wherein the information on the application functionality includes at least one corresponding model identifier for at least one corresponding model corresponding to the at least one candidate model, and the transmitting of the information on the application functionality comprises:
determining whether the terminal has the at least one corresponding model corresponding to the at least one candidate model; and
in response to determining that the terminal has the at least one corresponding model, transmitting, to the base station, the information on the application functionality including the at least one corresponding model identifier for the at least one corresponding model.

5. The method according to claim 4, wherein the information on the application functionality further includes at least one of: whether the at least one corresponding model has been trained, a stabilization rate of the at least one corresponding model, or model parameter values for training the at least one corresponding model.

6. The method according to claim 4, further comprising: receiving, from the base station, information on a model to use based on the at least one corresponding model.

7. The method according to claim 6, further comprising:
receiving, from the base station, a training request for the model to use;
training the model to use according to the training request; and
reporting, to the base station, a training result of the model to use.

8. The method according to claim 7, wherein the training result further includes at least one of a training status of the model to use or model parameter values for training.

9. A method of a base station, comprising:
transmitting a capability inquiry message to a terminal;
receiving, from the terminal, information on at least one support functionality supported by the terminal;
transmitting, to the terminal, information on at least one candidate model related to the at least one support functionality; and
receiving, from the terminal, information on an application functionality to be applied by the terminal based on the information on the at least one candidate model.

10. The method according to claim 9, wherein the information on the application functionality further includes at least one of: whether the at least one corresponding model has been trained, a stabilization rate of the at least one corresponding model, or model parameter values for training the at least one corresponding model.

11. The method according to claim 9, further comprising:
determining a model to use based on the application functionality; and
transmitting, to the terminal, information on the determined model to use.

12. The method according to claim 11, further comprising:
transmitting, to the terminal, a training request for the model to use; and
receiving, from the terminal, a training result of the model to use.

13. A terminal comprising at least one processor, wherein the at least one processor causes the terminal to perform:
receiving a capability inquiry message from a base station;
transmitting, to the base station, information on at least one support functionality supported by the terminal;
receiving, from the base station, information on at least one candidate model related to the at least one support functionality; and
transmitting information on an application functionality to be applied by the terminal to the base station based on the information on the at least one candidate model.

14. The terminal according to claim 13, wherein the information on the application functionality includes at least one corresponding model identifier for at least one corresponding model corresponding to the at least one candidate model, and in the transmitting of the information on the application functionality, the at least one processor further causes the terminal to perform:
determining whether the terminal has the at least one corresponding model corresponding to the at least one candidate model; and
in response to determining that the terminal has the at least one corresponding model, transmitting, to the base station, the information on the application functionality including the at least one corresponding model identifier for the at least one corresponding model.

15. The terminal according to claim 14, wherein the information on the application functionality further includes at least one of: whether the at least one corresponding model has been trained, a stabilization rate of the at least one corresponding model, or model parameter values for training the at least one corresponding model.

16. The terminal according to claim 14, wherein the at least one processor further causes the terminal to perform: receiving, from the base station, information on a model to use based on the at least one corresponding model.

17. The terminal according to claim 16, wherein the at least one processor further causes the terminal to perform:
receiving, from the base station, a training request for the model to use;
training the model to use according to the training request; and
reporting, to the base station, a training result of the model to use.
